(19) United States
(12) Patent Application Publication
(10) Pub. No.: US 2022/0113146 A1
(43) Pub. Date: Apr. 14, 2022

(54) METHOD AND SYSTEM FOR PLANNING A JOURNEY

(71) Applicant: VULOG, NICE (FR)

(72) Inventor: François COLON, Marseille (FR)

(73) Assignee: VULOG, NICE (FR)

(21) Appl. No.: 17/419,001

(22) PCT Filed: Dec. 24, 2019
(86) PCT No.: PCT/FR2019/053293

§ 371 Date: Jun. 28, 2021

(30) Foreign Application Priority Data
Dec. 28, 2018 (FR) 1874383

(51) Int. Cl. G01C 21/34

(52) U.S. Cl. CPC G01C 21/3423

(57) ABSTRACT

A method for planning a journey, including:—determining a starting point and an end point of the journey from an electronic device, selecting at least two vehicles for transport between the starting point and the end point where the journey includes a first journey section using a vehicle and a second journey section using a different vehicle, using a fleet of shared vehicles, attribution of statuses to the fleet vehicles, which statuses are at least: determination of the geographical positions of the fleet vehicles, as soon as the starting point and the end point of the journey are known by the server: selection of at least one vehicle in the fleet which is located between the starting point and the end point and which has the status ‘Available for reservation’, and calculation of a best route between the starting point and the end point.

### TECHNICAL FIELD

The invention relates to a method and a system for planning a journey.

The field of the invention particularly relates to methods for optimizing a journey between a point of origin and a point of destination, using suitable vehicles. The invention preferably, but not necessarily, applies to the planning of journeys in urban zones, of short distances particularly less than 50 Km, advantageously less than 10 Km.

### PRIOR ART

Generally, when a person is seeking to make a journey between a point of origin and a point of destination, they use a single transport vehicle: bus, subway, train, car, bicycle, etc.

The patent document WO2017160276 describes a system for planning a multimodal route. This route is segmented, it being possible to complete each segment with a different transport vehicle. A drawback of this system is that it is complex to implement. The choice of vehicles used is also limited, in such a way that the preparation of a journey is not optimal particularly in terms of speed, distance traveled, journey time, economic cost, carbon footprint.

The patent document U.S. Pat. No. 8,949,028 (KLAMPFL) describes a further system for planning a route. In practice, the user is however not certain of being able to use the vehicles on the route thus planned.

An aim of the invention is that of remedying the abovementioned drawbacks. A further aim of the invention is that of providing a method for facilitating the reservation of vehicles on a journey.

### DESCRIPTION OF THE INVENTION

The solution proposed by the invention is a method for planning a journey comprising the following steps:
determining, via a user's computer equipment, a point of origin of the journey and a point of destination of said journey,
selecting at least two transport vehicles between the point of origin and the point of destination in such a way that the journey includes at least a first journey segment using one vehicle and a second journey segment using another vehicle.
   This method further includes the following steps:
using a fleet of shared vehicles,
assigning, by a computer server, statuses to the vehicles of the fleet, said statuses being at least: “Available for reservation” and “Unavailable for reservation”,
determining, by the computer server, the geographic positions of the vehicles of the fleet,
once the point of origin and the point of destination of the journey are known to the computer server then: selecting, by said server, at least one vehicle of the fleet which is located between the point of origin and the point of destination and which has an “Available for reservation” status,
preparing, by the computer server, the quickest and/or shortest journey between the point of origin and the point of destination, said journey being prepared in such a way that at least one of the journey segments uses the selected vehicle,
sending this journey, via the computer server, to the user's computer equipment for validation,
if the journey is validated by the user, reserving, via the computer server, the selected vehicle.

A car-sharing or self-service vehicle service is a system wherein a company, a public body, a cooperative, an association, or a group of individuals, makes one or more vehicles (hereinafter “vehicle fleet”) available to “customers” or members of the service. Rather than having a personal vehicle, the service user has use of a vehicle only paid for the length of time needed. In other words, when a user uses a shared vehicle, they are billed a certain amount. The amount billed depending generally on the number of kilometers traveled and/or the time of use of the vehicle and/or the vehicle model or type. The rest of the time, the vehicle is intended to be used by other members.

One of the advantages of shared vehicles lies in that a user can vacate their vehicle where they wish. The position of these vehicles is therefore not fixed over time, but moving (hence the term “free-floating”), so that it is difficult to predict the location thereof in advance. The invention takes advantage of this specificity. The server will be able to build an optimal journey accounting for the shared vehicles which are available between the point of origin and the point of destination. The status assigned to the vehicles is hence a parameter specifically taken into account for preparing the journey. As the position of these vehicles is not fixed over time, but moving, it is difficult to predict the location thereof in advance. The number of journeys capable of being prepared by the server is therefore increased significantly with respect to the solution described in WO2017160276, such that said server is capable of optimizing the journey as much as possible, particularly in terms of duration and/or distance and consequently in terms of reducing the carbon footprint. In other words, the geographic positions of the shared vehicles of a fleet being variable over time, the server can use this feature to constantly create new journeys which will be the most suitable at a given time. Therefore, it is not a conventional system for computing the best route on fixed transport lines. The server locates all the vehicles available for reservation, and freezes those making it possible to complete the optimal journey, by reserving them. The user does not have to handle all the multimodal complexity of this type of journey.

Further advantageous features of the invention are listed below. Each of these features can be considered alone or in combination with the remarkable features defined above, and be the subject, where applicable, of one or more divisional patent applications:
According to an embodiment, the method comprises the following steps:—selecting, via the user's computer equipment, one or more preference criteria in respect of the vehicles to be used on the journey and the condition of use thereof;
sending this criterion or these criteria to the computer server;—preparing the journey, by the computer server, accounting for the constraint(s) determined by the preference criterion or criteria.
According to an embodiment, the method comprises the following step: retrieving, by the computer server, data making it possible to verify whether the selected vehicle meets all or some of the preference criteria, said data being retrieved by said server, from one or more databases accessible via a computer network, and/or by querying sensors installed on the vehicles of the fleet.
According to an embodiment, the method comprises the following steps:—fitting the vehicles of the fleet with a locking/unlocking device which, when they are activated by an item of equipment of said vehicles, render said vehicles physically unusable;—in the case of reservation of the selected vehicle: sending, by the computer server, an activation command of the locking/unlocking device of said vehicle;—sending a deactivation command of the locking/unlocking device of the selected vehicle, when the user uses said vehicle.
According to an embodiment, the method comprises the following steps:—using a first fleet of shared vehicles and a second fleet of shared vehicles, the type of vehicles of the first fleet being different from the type of vehicles of the second fleet;—assigning, by the computer server, statuses to the vehicles of the first fleet and to the vehicles of the second fleet, said statuses being at least “Available for reservation” and “Unavailable for reservation”;—determining, by the computer server, the geographic positions of the vehicles of the first fleet and the vehicles of the second fleet;—selecting, by the computer server, a first vehicle from the first fleet and a second vehicle from the second fleet, said selected vehicles being located between the point of origin and the point of destination and having an “Available for reservation” status;—preparing, by the computer server, the quickest and/or the shortest journey between the point of origin and the point of destination, said journey being prepared in such a way that the first journey segment uses the first selected vehicle, and the second journey segment uses the second selected vehicle;—sending this journey, via the computer server, to the user's computer equipment for validation;—if the journey is validated by the user, reserving, via the computer server, the first selected vehicle and the second selected vehicle.
According to an embodiment:—the first journey segment and the second journey segment are two consecutive segments;—the junction between the two journey segments is defined by an entry point where the user vacates a first vehicle used on the first journey segment and by an exit point where the user picks up a second vehicle used on the second journey segment;—the computer server prepares the journey in such a way that the distance between the entry point and the exit point is less than a predetermined value.
According to an embodiment, the method comprises the following step: using a public transport vehicle on at least one journey segment.
According to an embodiment, the method comprises the following steps:—saving, in a database, the vehicles belonging to at least two fleets of shared vehicles, the type of vehicles of the first fleet being different from the type of vehicles of the second fleet, said types being selected in the following family: self-driving car, car, motorcycle, bicycle, scooter, skateboard, self-balancing unicycle, self-balancing personal transporter;—selecting, in the database, by the computer server, a first vehicle from the first fleet and a second vehicle from the second fleet;—preparing, by the computer server, the quickest and/or shortest journey between the point of origin and the point of destination, said journey being prepared in such a way that the first journey segment uses the first selected vehicle, and the second journey segment uses the second selected vehicle.
According to an embodiment, the method comprises the following steps:—retrieving, by the computer server, data relating to the road traffic in a geographic zone including the point of origin and the point of destination,
selecting the vehicle type, by the computer server, based on the data retrieved.
According to an embodiment, the method comprises the following step after reserving the selected vehicle: sending, to the user's computer equipment, via the computer server, the location of said vehicle and a means for identifying said vehicle.

A further aspect of the invention relates to a system for planning a journey including:
a user's computer equipment adapted to determine a point of origin of the journey and a point of destination of said journey,
a computer server adapted to select at least two transport vehicles between the point of origin and the point of destination in such a way that the journey includes at least a first journey segment using one vehicle and a second journey segment using another vehicle,
a vehicle from a fleet of shared vehicles is used on at least one journey segment,
the computer server includes a processing unit and a memory comprising one or more computer applications wherein the instructions, when they are executed by said processing unit, enable said server to:
   assign statuses to the vehicles of the fleet, said statuses being at least: “Available for reservation” and “Unavailable for reservation”,
   determine the geographic positions of the vehicles of the fleet,
   in response to the knowledge of the point of origin and the point of destination of the journey: select at least one vehicle of the fleet which is located between the point of origin and the point of destination and which has an “Available for reservation” status,
   prepare the quickest and/or shortest journey between the point of origin and the point of destination, said journey being prepared in such a way that at least one of the journey segments uses the selected vehicle,
   send this journey to the user's computer equipment for validation,
   if the journey is validated by the user, reserve the selected vehicle.

### BRIEF DESCRIPTION OF THE FIGURES

Further advantages and features of the invention will emerge more clearly on reading the description of a preferred embodiment hereinafter, with reference to the appended drawings, made by way of indicative and non-limiting examples and wherein:

FIG. 1 illustrates an embodiment example of a system for implementing the invention,

FIG. 2 is an embodiment example of the steps of a method according to the invention.

### DESCRIPTION OF THE EMBODIMENTS

The method and system according to the invention will give rise to the handling of physical elements, particularly of signals (electric or magnetic) and of digital data, capable of being stored, transferred, combined, compared, etc., and suitable for leading to a desired result.

The invention implements one or more computer applications executed by computer equipment or servers. For the purposes of clarity, it should be understood according to the invention that “an item or equipment or server does something” signifies “the computer application executed by a processing unit of the equipment or server does something”. Likewise, “the computer application does something” signifies “the computer application executed by the processing unit of the equipment or server does something”.

Also for the purposes of clarity, the present invention is capable of referring to one or more “logical computer processes”. The latter correspond to the actions or results obtained by executing instructions of different computer applications. Also, it should also be understood according to the invention that “a logical computing process is adapted to do something” signifies “the instructions of a computer application executed by a processing unit do something”.

Also for the purposes of clarity, the following clarifications are provided for certain terms used in the description and the claims:
“Computing resource” can be understood non-restrictively as: component, hardware, software, file, connection to a computer network, quantity of RAM memory, hard drive space, bandwidth, processor speed, number of CPU, etc.
“Computer server” can be understood non-restrictively as: computer device (hardware or software) including computer resources to carry out the functions of a server and which offers services, computer, plurality of computers, virtual Internet server, virtual Cloud server, virtual platform-based server, virtual server on a local infrastructure, server networks, cluster, node, server farm, node farm, etc.
“Service” can be understood non-restrictively as the set of functionalities provided and carried out by a server and by at least one item of equipment connected to said server via a network. The service can comprise for example, the following functionalities: planning a journey, reserving a shared vehicle, locating a shared vehicle, remotely locking/unlocking a shared vehicle, etc.
“Query” denotes an execution order capable of following a communication protocol and comprising input parameters (question, information, etc.) and optionally return parameters (response, information, etc.), capable of arising in a format linked with the protocol used.
“Processing unit” can be understood non-restrictively as: processor, microprocessors, CPU (for Central Processing Unit).
“Computer hardware” represents one or more spare parts of an item of computer equipment and can be understood non-restrictively as hardware.
“Computer application” can be understood as: software, computer program, etc.
“Computer network” can be understood non-restrictively as: computer bus, personal area network (PAN), local area network (LAN, WLAN, etc.), wide area network (WAN), Internet network, Intranet network, Extranet network. The computer network is a set of interconnected computer equipment to exchange, securely or not, information and/or data according to a communication protocol (ISDN, Ethernet, ATM, IP, CLNP, TCP, HTTP, etc.).
“Database” can be understood non-restrictively as a structured and organized set of data saved on media accessible by computer equipment and capable of being queried, read and updated. Data can be inserted, retrieved, modified and/or deleted therein. Database management and access can be carried out by a set of computer applications which form a database management system (DBMS).
“Shared vehicle” or self-service vehicles (“car sharing”) is a vehicle made available to “customers” or members. The vehicle can be: a self-driving car, a car (combustion and/or electric engine), a motorcycle (combustion and/or electric engine), a bicycle (conventional or power-assisted), a scooter (conventional or power-assisted), a skateboard, a self-balancing unicycle, a self-balancing personal transporter, a boat, etc.
“Fleet” or “stock” can be understood as a plurality of shared vehicles belonging to a company, a public body, a cooperative, an association, a group of individuals.
As used here, unless specified otherwise, the use of the ordinal adjectives “first”, “second”, etc., to describe an object merely indicates that different occurrences of similar objects are mentioned and does not imply that the objects thus described must be in a given sequence, whether over time, in space, in a ranking or in any other way.

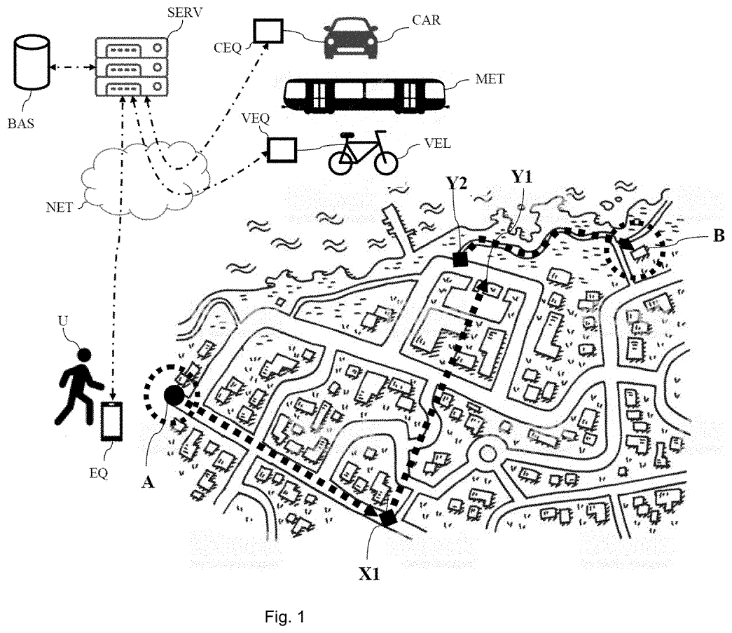

In FIG. 1, the system for implementing the method according to the invention comprises a computer server SERV, transport vehicles: a car CAR, a subway MET and a bicycle VEL, a user U. The geographic zone used to exemplify the invention is here an urban zone.

The user U has at least one item of computer equipment EQ which includes a communication interface, for example GSM, 3G, 4G or Wi-Fi, to establish a wireless link with the server SERV via a network NET. The latter is for example an Internet network, based on an infrastructure for carrying wireless communications from the equipment EQ. The latter is preferably a smartphone, a digital tablet, a laptop computer, etc. It comprises the computer resources, for example an executable code of a downloadable computer application, for carrying out functions of the method according to the invention. According to an embodiment, the user U is registered with a rights management server which can optionally be the remote server SERV. The user U then accesses a service corresponding to the planning of these journeys. The user registration can be carried out with a web service of a remote server associated with the service. The registration includes for example registering a user ID and a network address of the user equipment EQ, it can consist of a port, an IP address, a MAC address or any other address or combinations of constituent elements of addresses for identifying an item of user equipment EQ. According to an embodiment, the user U is preregistered using software and is known in that a login name is saved in a remote database BAS. According to an embodiment, the database BAS associates a vehicle CAR, VEL with a user U when the latter uses said vehicle. According to an embodiment, the server SERV includes a function for making the associations.

The subway MET is a public transportation (or public transit) vehicle. The invention should be understood as being capable of involving other types of public transportation vehicles such as: bus, coach, streetcar, train, cable car, boat, etc. These vehicles are generally organized by the public authorities and are adapted for the simultaneous accommodation of multiple persons, generally in exchange for the purchase of a fare (pass, ticket, transit pass, etc.).

The car CAR is a vehicle from a first fleet of shared vehicles. And the bicycle VEL is a vehicle from a second fleet of shared vehicles. The vehicles CAR and VEL are therefore of different types. The invention must be understood as being capable of involving vehicles from n fleets of shared vehicles, n being an integer greater than or equal to 1. To offer a very large number of transportation options to the user, each fleet preferably has a different type: self-driving car, car, motorcycle, bicycle, scooter, skateboard, self-balancing unicycle, self-balancing personal transporter, etc.

Each vehicle from each fleet is associated with a unique identification number. Each vehicle advantageously has at least one item of equipment CEQ, VEQ including a communication interface, for example GSM, 3G, 4G or Wi-Fi, to establish a wireless link with the server SERV via a network NET. The items of equipment CEQ, VEQ are preferably onboard computers comprising the computer resources for carrying out the functions of the method according to the invention. The server SERV assigns statuses to each vehicle from each fleet:
so-called “Available for reservation” status: the vehicle is parked and not reserved,
so-called “Unavailable for reservation” status: either the vehicle is parked but already reserved by a user (“Unavailable-Reserved” status), or the vehicle is in use (“Unavailable-in use” status). Other types of similar statuses can be provided.

The server SERV regularly updates, preferably in real time, the vehicle database of each fleet. This database BAS particularly includes: the ID of each vehicle, the status thereof (“Available for reservation” or “Unavailable for reservation”), and the geographic position thereof. Further information and/or data can be included in the database, where applicable. The database can be saved in a memory zone of the server SERV or be remote from said server and connected thereto.

The information on the status of a vehicle is sent to the server SERV in real time or at predefined time intervals (for example every 5 minutes). This information can be sent to the server SERV:
by the onboard equipment CEQ, VEQ of the vehicle following a detection of an event. This event is for example generated by an action of the user on a specific control provided on the vehicle CAR, VEL. This control can be actuated when the user has vacated the vehicle after a journey. The status then changes from “Unavailable for reservation” to “Available for reservation”,
by the equipment EQ of the user U of the vehicle CAR, VEL, following an action of said user on their equipment. The user can for example actuate a dedicated button displayed on a touchscreen of their equipment, after having parked and vacated their vehicle. The status then changes from “Unavailable for reservation” to “Available for reservation”.

When the server SERV receives a reservation request from a user subscribed to a vehicle sharing service, and it can grant this request (i.e., a vehicle is available for reservation), said server changes the status of a vehicle from “Available for reservation” to “Unavailable for reservation”. This reservation request can for example be generated via an item of electronic equipment or via a computer application to which the user is a subscriber.

The geographic position of each vehicle from each fleet can be obtained by satellite (GPS or Galileo system) or by a triangulation system (for example, a system using the cells of a 4G network) or by a combination of two location systems. The equipment CEQ, VEQ of a vehicle CAR, VEL advantageously includes a component, for example a GPS component, for obtaining an item of geolocation information which can be retrieved by the server SERV. The server SERV can automatically retrieve this information by querying in real time or at regular time intervals (for example every 5 minutes), the equipment CEQ, VEQ of the vehicles CAR, VEL. The equipment CEQ, VEQ of the vehicles CAR, VEL can also automatically send this information to the server SERV (without responding to a query request), in real time or at regular time intervals (for example every 5 minutes). According to an alternative, the geographic position of a vehicle CAR, VEL can correspond to a position defined using an input interface of an item of equipment EQ of a user U using the vehicle CAR, VEL. For example, the user U can evaluate a position using an interactive map displayed on a graphic interface of their equipment EQ. This position is then sent to the server SERV:

In the example in FIG. 1, the user U wishes to make a journey, in an urban zone, for example between their place of residence (point of origin A) and the office where they work (point of destination B). To do this, they send the server SERV a journey planning request, which is for example generated from their equipment EQ, via a computer application to which said user is a subscriber. This planning request includes the point of origin A and the point of destination B. The position of the point of origin A can be entered manually via an interface of the equipment EQ, for example by entering an address or by selecting a point on an interactive map displayed on said graphic interface. According to an alternative, the position of the point of origin A is by default the geographic position of the user U when they send their planning request. This position can be obtained by satellite (GPS or Galileo system) or by a triangulation system (for example, a system using the cells of a 4G network) or by a combination of two location systems. Also, the equipment EQ advantageously includes a component, for example a GPS component, for obtaining an item of geolocation information which is automatically included in the planning request. The position of the point of destination B can also be entered manually via an interface of the equipment EQ, for example by entering an address or by selecting a point on an interactive map displayed on said graphic interface. The position of the point of destination B is then included in the planning request and sent to the server SERV.

The server SERV advantageously incorporates one or more digital mapping and route calculation computer applications, in such a way that it has an exhaustive knowledge of the streets, traffic lanes, sidewalks, located between the point A and the point B. Similarly, the server SERV advantageously incorporates one or more public transportation map and public transportation route calculation computer applications, in such a way that between the point A and the point B, and for each type of transport, it knows the stops (or station), the schedules, the distance and the travel time between an origin stop and a destination stop, etc. Alternatively, the server SERV is adapted to be connected to one or more digital mapping (including public transportation maps) and route calculation (including public transportation routes) websites to retrieve this information.

Within the scope of the present invention, the server SERV analyzes the planning request of the user U and retrieves the positions of the points of origin A and of destination B. The server SERV then queries the database BAS to determine the vehicles of the different fleets for which the geographic position, at this time, is located between the points A and B. For example, the server SERV defines a geographic zone included in a circle (respectively a rectangle or a square) in which the diameter (respectively the diagonal) corresponds to the distance between the points A and B. All the vehicles for which the geographic position is located in this zone are analyzed. The server SERV refines the results of this search to only select in the database BAS, the vehicles which have an “Available for reservation” status. In the example in FIG. 1, the server SERV observes that the car CAR from a fleet of shared cars and a bicycle VEL from a fleet of shared bicycles are available between the point A and the point B.

The server SERV prepares the quickest and/or shortest journey between the point of origin A and the point of destination B, accounting for the availability, positions and types of the vehicles CAR and VEL selected. This journey is multimodal, i.e., it includes several journey segments connected by hubs. The journey is prepared in such a way that the car CAE is used on one journey segment and the bicycle VEL on another journey segment. In the example in FIG. 1, the server calculates that the quickest journey with the lowest carbon footprint, consists in using the car CAR on a first journey segment (initial segment A-X1), using the subway on a second journey segment (intermediate segment X1-Y1) and using the bicycle on a third journey segment (final segment Y2-B). The server SERV then sends this optimal journey proposal to the equipment EQ of the user U for validation. This journey proposal can be accompanied by the journey time and/or distance, price, CO₂ emission generated. The server can furthermore propose alternative journeys in addition to this optimal journey. For example, the server SERV can propose a shorter journey but with a higher carbon footprint, consisting in using the car CAR from the point A to the point Y2 and using the bicycle VEL on the final segment Y2-B calculates the quickest journey. The server SERV can furthermore propose a longer journey but with a lower carbon footprint, consisting in walking from the point A to the point X1, using the subway on the intermediate segment X1-Y1 and using the bicycle on the final segment Y2-B. The transmission of the optimal journey and optionally of the alternative journeys, is accompanied by a validation request. The latter is presented for example in the form of a selectable validation button which is displayed on the interface of the equipment EQ.

The hypothesis retained here is that the user U validates the optimal journey. This validation can be presented in the form of a validation command sent to the server SERV from the equipment EQ. The server SERV will then reserve the car CAR and the bicycle VEL. In the database BAS, their status will change from “Available for reservation” to “Unavailable for reservation” such that no other user will be able to use them. The user U is thus assured to be able to use these vehicles on their journey. The wording “Unavailable for reservation” can furthermore be displayed on a graphic interface installed visibly on each vehicle CAR, VEL.

In addition or alternatively to the change of status of the vehicles CAR and VEL, the server SERV can render said vehicles physically unusable by persons other than the user U. Indeed, the vehicles CAR and VEL can be equipped with a remote locking/unlocking device. For the car CAR, it can consist of an engine immobilizer controlled by the equipment CEQ. For the bicycle VEL, it can consist of a wheel locking device controlled by the equipment VEQ. Thus, after the journey has been validated by the user U, the server SERV sends the equipment CEQ and VEQ, via the network NET, a locking device activation command, rendering the vehicles CAR and VEL momentarily unusable. When the user U accesses one of the vehicles CAR, VEL, they can send the equipment CEQ, VEQ, from their equipment EQ, for example via a Wi-Fi or Bluetooth type wireless link or after scanning a barcode or NFC chip, a locking device deactivation command, rendering said vehicle usable. Alternatively, the server SERV can detect, particularly by geolocation, that the position of the user (i.e., of their equipment EQ), coincides with that of the vehicle concerned CAR or VEL. As such, the server SERV sends the respective equipment CEQ or VEQ, via the network NET, the deactivation command.

When the user U validates the journey, the server SERV sends the equipment EQ, a validation confirmation, with which is associated an interactive map showing in detail the route of the journey selected and which is displayed on a graphic interface of said equipment. Preferably, the server SERV very accurately indicates the location of the reserved vehicles CAR, VEL (for example by indicating the geographic position on the interactive map) and a means for identifying said vehicles. This identification means can be presented in the form of a photo of the vehicles, the license plate number of the car CAR, an identification number marked on the bicycle CEL, etc.

According to an embodiment, the user U can enter one or more preference criteria in respect of the vehicles to be used on the journey and the condition of use thereof. When signing up to the planning service or during the preparation of their planning request, the user U can for example specify, via the graphic interface of their equipment EQ, a certain number of criteria. These criteria are personalized. They can for example specify that they never want to use a self-balancing personal transporter (e.g.: SEGWAY®) or a skateboard, or a motorbike, that they agree to use the subway except during peak times between 5 p.m. and 7 p.m., that they like cars and particularly self-driving cars, and that they agree to use a bicycle over distances less than or equal to 1 Km, except in the event of rain or if the outside temperature exceeds 30° C. These constraints are sent to the server SERV, when the user U signs up to the planning service and/or at the same time as the transmission of their planning request. Advantageously, the server SERV associates these criteria with the user's login name and saves them in the database BAS, particularly to account for the resulting constraints in future planning processes. The server SERV can then prepare the journey accounting for the constraint(s) determined by this preference criterion or these preference criteria.

Taking the example of FIG. 1, if the server SERV observes that a motorbike, a conventional car or a self-driving car are all three available at the point of origin A, it will not select the motorbike, and will prefer the shared car over the conventional car. Similarly, if the distance between the exit of the subway Y1 and the point B is greater than 1 Km, the server SERV will not select the bicycle VEL to travel the final segment Y2-B. The same applies if it rains or if the outside temperature exceeds 30° C. The server SERV will then select another shared vehicle, hence preparing another journey than that illustrated in FIG. 1.

It is therefore advantageous that the server SERV can retrieve data for verifying whether the selected vehicles CAR, VEL meet all or some of the preference criteria, particularly the weather conditions of use thereof. These data can be retrieved in several ways:
the server SERV can be adapted to login to one or more databases from weather or digital mapping websites to retrieve this information, and/or
the server SERV queries sensors installed on shared vehicles (temperature sensor, humidity sensor, etc.).

The server SERV can also retrieve, from dedicated websites, data relating to the road traffic in the geographic zone including the point of origin A and the point of destination B. These traffic data are for example: heavy traffic in a particular zone, or flowing traffic in another zone, a particular street closed to traffic, road works in another street, etc. The server SERV will then take these data into account to select a vehicle type and prepare its journey. For example, if the server SERV detects that the segment Y2-B passes through a street wherein the traffic is heavy or wherein road works are being carried out, it will prefer the use of a small-sized vehicle such as a bicycle, scooter, skateboard, self-balancing unicycle, or self-balancing personal transporter. The preference criteria mentioned above, enable the server SERV to refine its selection and to choose the most suitable vehicle for the user U, the bicycle VEL in the example in FIG. 1.

The data relating to the road traffic are also used by the server SERV to define its journey optimization strategy. Based on FIG. 1, the user U lives for example in the suburbs (point A) of a city and wishes to travel to their workplace (Point B) located in the city center. The server observes that at the time when the user sends their planning request, access to the city center is difficult as the traffic is very heavy. The server SERV will then prepare its journey to propose to the user U a self-driving car CAR which will pick them up within 15 min in front of their home (Point A). The self-driving car CAR will drop the user U off in front of a subway entrance (Point X1). This subway will arrive 10 min later at a station determined by the server (Point Y1). At the exit from this station, a bicycle VEL, located 50 m from said station (point Y2) will be reserved and will enable the user U to reach their workplace (Point B).

The junction (or hub) between two consecutive journey segments, for example the junction between the intermediate segment X1-Y1 and the final segment Y2-B, is defined by an entry point Y1 (e.g.: the exit of the station where the user leaves the subway MET) and an exit point (e.g.: the location where the user picks up the bicycle VEL). Advantageously, the server SERV prepares the journey in such a way that the distance between the entry point Y1 and the exit point Y2 is less than a predetermined value, for example less than 100 m. If the bicycle VEL was available but located 200 m from the exit of the subway Y1, the server SERV would not have selected said bicycle, but opted for another available vehicle and in fact, would have defined another journey. It would have for example suggested to the user U to exit at the next subway station to pick up a scooter located 20 m from the exit of this station.

The invention also relates to a computer program product including instructions for the implementation of the different steps of the method of the invention. The steps can be carried out by a computer program saved in the memory of the server SERV and wherein the instructions are executed by the processing unit of said server. According to different embodiments, steps of the method can be carried out by the equipment EQ of the user and/or by an item of equipment CEQ, VEQ of a shared vehicle CAR, VEL.

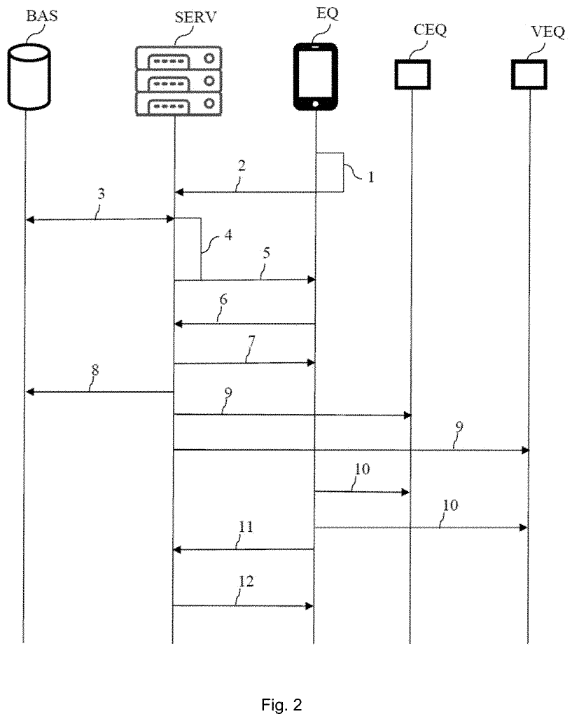

FIG. 2 represents a block diagram of the main steps of a method according to the invention. FIG. 2 schematically represents five entities represented in FIG. 1, namely the database BAS, the server SERV, the equipment EQ of the user U and the equipment CEQ, VEQ of the shared vehicles CAR, VEL. According to a preferred embodiment:
Event 1: generation of a planning request by the user, via their equipment EQ. The user enters the point of origin A, the point of destination B, and optionally one or more preference criteria.
Step 2: transmission of this request to the server SERV, from the equipment EQ.
Step 3: the server SERV queries the database BAS to select shared vehicles (CAR, VEL) located between the point of origin and the point of destination and whose status is “Available for reservation”. At this stage, the server SERV can also query other websites and/or databases and/or the equipment CEQ, VEQ, to retrieve digital mapping data, public transportation map data, data for verifying whether the selected vehicles CAR, VEL meet all or some of the preference criteria, data relating to the road traffic, etc.
Event 4: the server SERV implements the computer process for calculating the quickest and/or shortest journey. The journey is prepared in such a way that the selected vehicles CAR, VEL are used on different journey segments. This calculation can be carried out at the same time as step 3.
Step 5: the server SERV sends the user's equipment EQ, a suggested optimal journey, optionally accompanied by other alternative journeys.
Step 6: the user validates the journey. The equipment EQ sends the server SERV the journey validation command.
Step 7: the server SERV sends the equipment EQ a validation confirmation with which is associated an interactive map showing in detail the route of the journey, the location of the reserved vehicles CAR, VEL, and optionally an identification means of said vehicles.
Step 8: the server SERV reserves the vehicles CAR, VEL by modifying the database BAS to change the status thereof from “Available for reservation” to “Unavailable for reservation”.
Step 9: the server SERV sends the equipment CEQ, VEQ, a locking device activation command, rendering the vehicles CAR, VEL momentarily unusable.
Step 10: the user U accesses the vehicles CAR, VEL. A locking device deactivation command is sent to the equipment CEQ, VEQ, from the equipment EQ.
Step 11: the user U has finalized their journey. The equipment EQ sends the server SERV an end-of-journey indicator, for example generated after activating a dedicated button displayed on a graphic interface of said equipment.
Step 12: the server SERV determines the amount to be billed to the user and sends, to the equipment EQ, the corresponding bill.
   Steps 11 and 12 are optional. The billing step 12 can be carried out between step 6 and step 7 or 8, i.e., after the validation of the journey by the user and before the confirmation and/or the reservation of the vehicles CAR, VEL. Payment of this bill can moreover be the triggering element of step 7 or step 8.

The arrangement of the different elements and/or means and/or steps of the invention, in the embodiment described above, should not be understood as requiring such an arrangement in all the implementations. In particular, one or more features described only in one embodiment can be combined with one or more future features described only in a further embodiment.

1-11. (canceled)

12. Method for planning a journey, comprising:
determining, via an item of computer equipment of a user, a point of origin of the journey and a point of destination of said journey,
selecting at least two transport vehicles between the point of origin and the point of destination in such a way that the journey includes at least a first journey segment using one vehicle and a second journey segment using another vehicle, and further comprising:
using a fleet of shared vehicles,
assigning, by a computer server, statuses to the vehicles of the fleet, said statuses being at least: “Available for reservation” and “Unavailable for reservation”,
determining, by the computer server, the geographic positions of the vehicles of the fleet,
once the point of origin and the point of destination of the journey are known to the computer server then: selecting, by said server, at least one vehicle of the fleet which is located between the point of origin and the point of destination and which has an “Available for reservation” status,
preparing, by the computer server, the quickest and/or shortest journey between the point of origin and the point of destination, said journey being prepared in such a way that at least one of the journey segments uses the selected vehicle,
sending this journey, via the computer server, to the computer equipment of the user for validation, and
if the journey is validated by the user, reserving, via the computer server, the selected vehicle. 13 (New). Method according to claim 12, further comprising:
selecting, via the computer equipment of the user, one or more preference criteria in respect of the vehicles to be used on the journey and the condition of use thereof,
sending this criterion or these criteria to the computer server,
preparing the journey, by the computer server, accounting for the constraint(s) determined by the preference criterion or criteria.

14. Method according to claim 13, further comprising: retrieving, by the computer server, data for verifying whether the selected vehicle meets all or some of the preference criteria, said data being retrieved by said server:
from one or more databases accessible via a computer network, and/or
by querying sensors installed on the vehicles of the fleet.

15. Method according to claim 12, further comprising:
fitting the vehicles of the fleet with a locking/unlocking device which, when they are activated by an item of equipment of said vehicles, render said vehicles physically unusable,
in the case of reservation of the selected vehicle: sending, by the computer server, an activation command of the locking/unlocking device of said vehicle, and
sending a deactivation command of the locking/unlocking device of the selected vehicle, when the user uses said vehicle.

16. Method according to claim 12, further comprising:
using a first fleet of shared vehicles and a second fleet of shared vehicles, the type of vehicles of the first fleet being different from the type of vehicles of the second fleet,
assigning, by the computer server, statuses to the vehicles of the first fleet and to the vehicles of the second fleet, said statuses being at least “Available for reservation” and “Unavailable for reservation”,
determining, by the computer server, the geographic positions of the vehicles of the first fleet and of the vehicles of the second fleet,
selecting, by the computer server, a first vehicle from the first fleet and a second vehicle from the second fleet, said selected vehicles being located between the point of origin and the point of arrival and have an “Available for reservation” status,
preparing, by the computer server, the quickest and/or shortest journey between the point of origin and the point of destination, said journey being prepared in such a way that the first journey segment uses the first selected vehicle, and that the second journey segment uses the second selected vehicle,
sending this journey, via the computer server, to the computer equipment of the user for validation, and
if the journey is validated by the user, reserving, via the computer server, the first selected vehicle and the second selected vehicle.

17. Method according to claim 12, wherein:
the first journey segment and the second journey segment are two consecutive segments,
the junction between the two journey segments is defined by an entry point where the user vacates a first vehicle used on the first journey segment and by an exit point where the user picks up a second vehicle used on the second journey segment, and
the computer server prepares the journey in such a way that the distance between the entry point and the exit point is less than a predetermined value.

18. Method according to claim 12, further comprising: using a public transportation vehicle (MET) on at least one journey segment.

19. Method according to claim 12, further comprising:
saving, in a database, the vehicles belonging to at least two fleets of shared vehicles, the type of vehicles of the first fleet being different from the type of vehicles of the second fleet, said types being selected in the following family: self-driving car, car, motorcycle, bicycle, scooter, skateboard, self-balancing unicycle, self-balancing personal transporter,
selecting, in the database, by the computer server, a first vehicle from the first fleet and a second vehicle from the second fleet, and
preparing, by the computer server, the quickest and/or shortest journey between the point of origin and the point of destination, said journey being prepared in such a way that the first journey segment uses the first selected vehicle, and that the second journey segment uses the second selected vehicle.

20. Method according to claim 19, further comprising:
retrieving, by the computer server, data relating to the road traffic in a geographic zone including the point of origin and the point of destination, and
selecting the type of vehicle, by the computer server, based on the data retrieved.

21. Method according to claim 12, further comprising, after reserving the selected vehicle:
sending, to the computer equipment of the user, from the computer server, the location of said vehicle and an identification means of said vehicle.

22. System for planning a journey including:
an item of computer equipment of a user adapted to determine a point of origin of the journey and a point of destination of said journey,
a computer server adapted to select at least two transport vehicles between the point of origin and the point of destination in such a way that the journey includes at least a first journey segment using one vehicle and a second journey segment using another vehicle, and further comprising:
a vehicle from a fleet of shared vehicles is used on at least one journey segment,
the computer server includes a processing unit and a memory comprising one or more computer applications wherein the instructions, when they are executed by said processing unit, enable said server to:
assign statuses to the vehicles of the fleet, said statuses being at least: “Available for reservation” and “Unavailable for reservation”,
determine the geographic positions of the vehicles of the fleet,
in response to the knowledge of the point of origin and the point of destination of the journey: select at least one vehicle of the fleet which is located between the point of origin and the point of destination and which has an “Available for reservation” status,
prepare the quickest and/or shortest journey between the point of origin and the point of destination, said journey being prepared in such a way that at least one of the journey segments uses the selected vehicle,
send this journey to the computer equipment of the user for validation, and
if the journey is validated by the user, reserve the selected vehicle.
